(19) United States
(12) Patent Application Publication
(10) Pub. No.: US 2017/0182854 A1
(43) Pub. Date: Jun. 29, 2017

(54) RELEASABLE RETAINER FOR A HITCH ASSEMBLY

(71) Applicant: Snider-Slinkard Partnership, Bernie, MO (US)

(72) Inventor: Gene Ray Slinkard, Bernie, MO (US)

(21) Appl. No.: 15/458,616

(22) Filed: Mar. 14, 2017

Related U.S. Application Data
(62) Division of application No. 14/956,020, filed on Dec. 1, 2015, now abandoned.

(51) Int. Cl. B60D 1/28; B60D 1/06

(52) U.S. Cl. CPC B60D 1/28; B60D 1/065

(57) ABSTRACT

An apparatus connects a coupler associated with a trailer to a hitch receiver using a tow ball for connecting the trailer to a vehicle via the coupler. A ball mount supports the tow ball and includes a retainer having a first pin for engaging the hitch receiver and an actuator for withdrawing the first pin from engagement. The actuator is configured to prevent the withdrawal of the first pin when the coupler is present on the tow ball. An apparatus is also provided for connecting a coupler associated with a trailer to a vehicle including a hitch receiver adapted for receiving a ball mount supporting a tow ball. The apparatus includes a retainer adapted for positioning over the hitch receiver, the retainer including a first pin for connecting the ball mount to the hitch receiver, and an actuator for disconnecting the first pin from the ball mount.

This application is a divisional of U.S. patent application Ser. No. 14/956,020, which claims the benefit of U.S. Provisional Patent Application Ser. Nos. 62/124,937 and 62/178,161, the disclosures of which are incorporated herein by reference.

### TECHNICAL FIELD

This document relates generally to the vehicle arts and, more particularly, to a releasable retainer for a hitch assembly used in connection with a vehicle for towing an object, such as a trailer.

### BACKGROUND

A typical towing arrangement, as shown in FIG. 1, includes a ball mount M for connecting with a coupler C, which is in turn connected to a trailer or the like (not shown but see arrow T indicating towing direction of trailer). The ball mount M carries the tow ball (not shown) for engaging the coupler C and transmitting the towing force, and includes a shank S extending into a hitch receiver R connected to a vehicle V.

Typically, a removable pin P is used to connect the shank S to the hitch receiver R. However, the pin P is subject to becoming easily displaced, which could allow for the inadvertent release of the trailer during travel. Even when not traveling, nothing prevents the pin P from being removed and the trailer stolen.

This document relates to a releasable retainer for a hitch assembly that overcomes these and perhaps other problems. The retainer would provide for the secure attachment of the ball mount to a hitch receiver to prevent inadvertent release, including when a coupler is present on a tow ball, yet would still be easily released when desired. The retainer would also not interfere with the normal operation of the hitch arrangement and, in some embodiments, could be used in a retrofit situation with existing hitch technology.

### SUMMARY

In accordance with the purposes and benefits described herein an apparatus for connecting a coupler associated with a trailer to a hitch receiver using a tow ball for connecting the trailer to a vehicle via the coupler is provided. The apparatus includes a ball mount for supporting the tow ball. The ball mount includes a retainer having a first pin for engaging the hitch receiver and an actuator for withdrawing the first pin from engagement with the hitch receiver. The actuator is configured to prevent the withdrawal of the first pin when the coupler is present on the tow ball.

In one embodiment, the actuator comprises a handle, a connector connected to the handle, and a cam connected to the connector for engaging the first pin. The cam may comprise a slot for engaging a follower connected to the first pin, the slot adapted for causing the first pin to move to and fro in a direction transverse to a towing direction. The connector may be biased for maintaining the first pin in engagement with the hitch receiver.

The retainer may further include a second pin for engaging the hitch receiver, and the actuator may be configured for simultaneously withdrawing the first and second pins from engagement with the hitch receiver. In such case, the cam may include a first slot for engaging a first follower connected to the first pin, the first slot adapted for causing the first pin to move to and fro transverse to a towing direction, and a second slot for engaging a second follower connected to the second pin, the second slot adapted for causing the second pin to move to and fro transverse to the towing direction.

The actuator may be adapted for moving toward the coupler when present on the tow ball an amount less than a distance required to release the first pin from engagement with the receiver. The ball mount may include a platform having a sloping portion, and the actuator comprises a handle mounted adjacent to the sloping portion so as to form a gap configured for receiving a finger of an operator for engaging the handle and moving it toward the tow ball to release the retainer. The handle may be connected to a connector extending through an aperture in the sloping portion.

According to a further aspect of the disclosure, an apparatus for connecting a coupler associated with a trailer to a hitch receiver using a tow ball for connecting the trailer to a vehicle via the coupler is provided. The apparatus comprises a ball mount for supporting the tow ball. The ball mount includes a retainer having a first pin for engaging the hitch receiver and a movable cam for engaging and withdrawing the first pin from engagement with the hitch receiver, the cam having a first travel amount in a first mode of operation that is less than an amount required to withdraw the first pin from engagement with the hitch receiver and a second travel amount in a second mode of operation that is greater than the amount required to withdraw the first pin from engagement.

In accordance with a further aspect of the disclosure, an apparatus for connecting a coupler associated with a trailer to a vehicle including a hitch receiver adapted for receiving a ball mount supporting a tow ball is provided. The apparatus comprises a retainer adapted for positioning over the hitch receiver, the retainer including a first pin for connecting the ball mount to the hitch receiver and an actuator for disconnecting the first pin from the ball mount.

In one embodiment, the retainer comprises a first receiver for receiving the first pin so as to permit relative movement toward and away from the hitch receiver. A support forming part of the retainer may be adapted for engaging the hitch receiver, with the support supporting the first receiver. The position of the first receiver relative to the support may be adjustable in alignment with a towing direction, and a fastener may be provided for fastening the support to the hitch receiver. The retainer may include an adjustable stop for preventing the withdrawal of the first pin from engagement with the hitch receiver.

The actuator may comprise a first handle for moving the first pin in a direction transverse to a towing direction, or may comprise a rotary actuator. The retainer may include a second pin for connecting the ball mount to the hitch receiver, and the actuator may be adapted for moving the second pin in concert with the first pin for engaging the ball mount when positioned in the hitch receiver. The retainer may be generally U-shaped, or may include a collar for engaging an oversized end of the hitch receiver. The retainer may also form an integral part of the hitch receiver.

A further aspect of the disclosure pertains to methods of retaining a ball mount. In one embodiment, the method comprises preventing the release of one or more pins connecting the ball mount to a hitch receiver by restricting the movement of an actuator. A further embodiment comprises placing a retainer over a hitch receiver to retain the ball mount.

In the following description, there are shown and described several preferred embodiments of the releasable retainer for use in connection with a hitch assembly for connecting a vehicle with an object to be towed, such as a trailer. As should be realized, the retainer is capable of other, different embodiments and its several details are capable of modification in various, obvious aspects all without departing from the retainer as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification illustrate several aspects of the retainer and together with the description serve to explain certain principles thereof.

FIG. 1 is an illustration of one possible environment of use of a retainer according to the disclosure;

FIG. 2 is a perspective view of one embodiment of the retainer;

FIG. 3 is a top view of the retainer of FIG. 2;

FIG. 4 is a side view of the retainer of FIG. 2;

FIG. 5 is a front view of the retainer of FIG. 2;

FIG. 6 is a perspective view of the actuator associated with the retainer of FIG. 2;

FIG. 6 is a bottom view of the actuator of FIG. 6;

FIG. 8 is a perspective view of another embodiment of a retainer;

FIG. 9 is a top view of the retainer of FIG. 8;

FIG. 10 is a right side view of the retainer of FIG. 8;

FIG. 11 is a front view of the retainer of FIG. 8;

FIG. 12 is a left side view of the retainer of FIG. 12;

FIG. 13 is a front view of the actuator of FIG. 14;

FIG. 14 is a perspective view of the actuator associated with the retainer of FIG. 8;

FIG. 15 is a close up view of the left side of the retainer of FIG. 8;

FIG. 16 is a side view of a ball mount;

FIGS. 17-20 are perspective views of a further embodiment of a retainer;

FIGS. 21-22 are perspective and end views of still a further embodiment of a retainer;

FIGS. 23-24 are end views of yet another retainer; and

FIGS. 25, 26, and 27 are front, side, and top views of another embodiment of a retainer.

Reference will now be made in detail to the present embodiments of the releasable retainer of the disclosure, examples of which are illustrated in the accompanying drawing figures.

### DETAILED DESCRIPTION

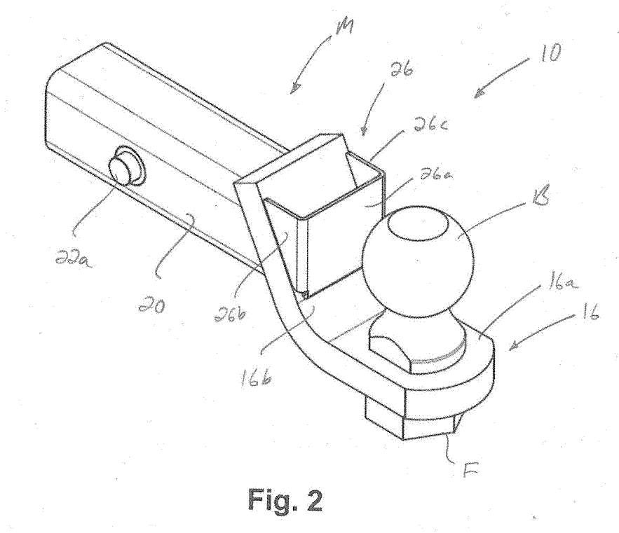

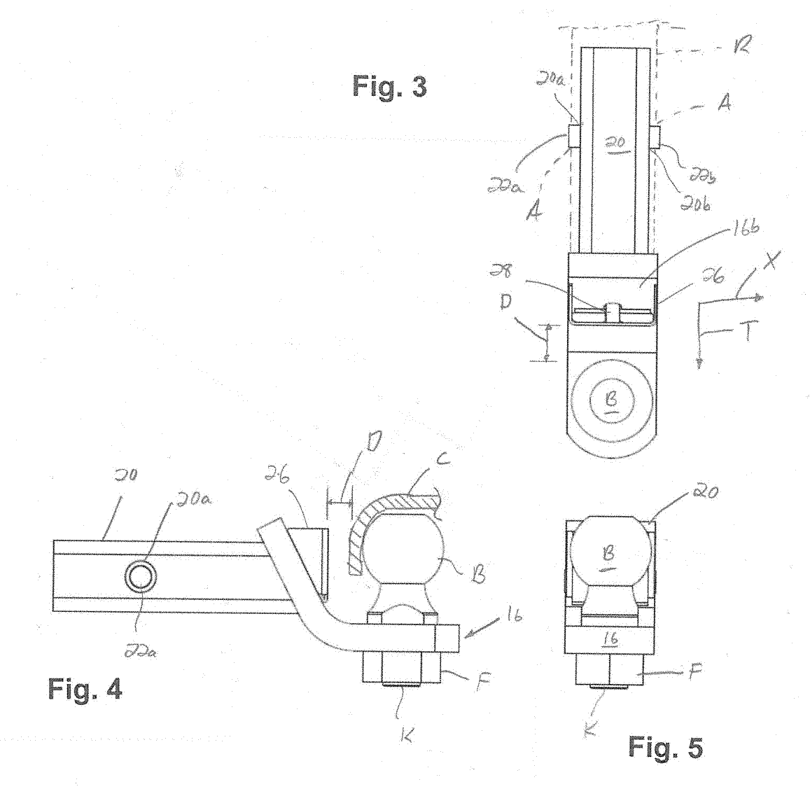

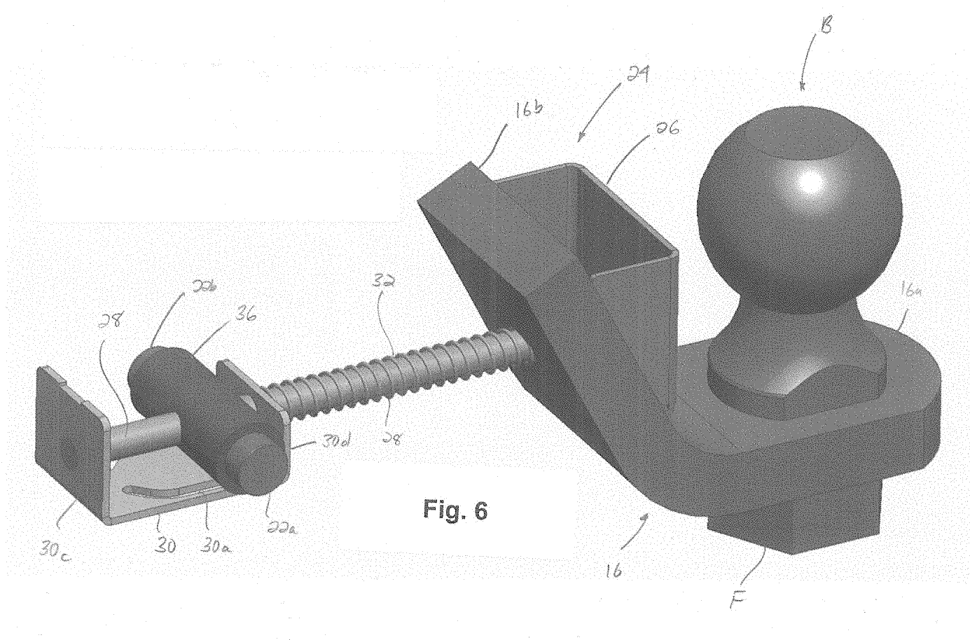

Reference is now made to FIG. 2, which illustrates one possible embodiment of a releasable retainer 10 according to the disclosure. The retainer 10 in this embodiment is associated with a ball mount M for supporting a tow ball B, which optionally forms part of the assembly. Support for the tow ball B is provided by a platform 16 having a generally planar support face 16a with an aperture therein for receiving a threaded shank K for connecting to a fastener F, such as a hex nut. The platform 16 includes an integral portion rearward of the tow ball 16, which is shown as being a sloped face 16b connected (such as by welding) to a shank 20 adapted for being inserted into a hitch receiver R (see FIG. 3).

With further reference to FIGS. 4 and 5, it can be understood that the mount M includes at least one, and preferably at least two, releasable pins 22a, 22b. The pins 22a, 22b are adapted to move relative to the shank 20 for positioning in aligned apertures of the hitch receiver R in order to secure the ball mount M in place for a towing operation. Specifically, the pins 22a, 22b may be extended through passages 20a, 20b and thus project from the lateral sides of the shank 20 into the apertures A in order to connect the ball mount M to the receiver R. Likewise, the pins 22a, 22b may be withdrawn to release the shank 20 and thus allow for withdrawal of the mount M from the receiver R, which is done in alignment with a towing direction (see arrow T).

Actuation of the pins 22a, 22b may be achieved using a variety of different types of actuators. As one example, an actuator 24 is provided which comprises handle, such as a pull 26 supported by the ball mount M. In particular, the pull 26 is supported along the sloped face 16b in a manner that allows for movement in alignment with the towing direction T for pulling a connector, such as an elongated rod 28 passing through a passage in this face and connected to a cam 30 within the shank 20. The cam 30 includes slots 30a, 30b with an inwardly directed portion for engaging a follower 34a, 34b associated with each pin 22a, 22b. As a result of the engagement, these pins 22a, 22b move to and fro in a transverse direction T relative to a fixed, tubular receiver 36 (through which the rod 28 serving as the connector may extend to connect with a rear wall 30c of cam 30) as a result of relative movement in alignment with the towing direction T caused by moving of the pull 26.

The nominal position of the actuator 24 may be such that the pins 22a, 22b are normally engaged. Thus, a spring 32 may be provided to urge the cam 30 toward a position in which the pins 22a, 22b are extended (note forward, generally vertical wall 30d of cam 30 for engaging the distal end of the spring). The biasing force thus created is overcome by the movement of the cam 30 caused by the pulling of the rod 28. Hence, the pins 22a, 22b are normally in the extended condition as a result, and are retracted by engaging the pull 26 to allow for withdrawal of the shank 20 and thus the ball mount M from the receiver R.

According to one aspect of the disclosure, the actuator 24 is adapted to prevent release of the ball mount M from the receiver R when a certain operating condition is met, such as when the coupler C is in position on a tow ball B, as shown in FIG. 4. Specifically, as a result of the presence of coupler C on the ball B (which may be considered a first mode of operation), the distance D that the pull 26 may extend in alignment with the towing direction T is less than an amount required for the cam 30 to move to release the pins 22a, 22b from engagement with the receiver R. In other words, the rod 28 cannot move the cam 30 such that the inwardly directed portion of the slots 30a, 30b causes the pins 22a, 22b to move in a transverse direction X an amount necessary to allow the ends of the pins to clear the inner surface of the receiver R associated with the apertures A.

In this way, release of the ball mount M from the receiver R is prevented so long as the coupler C remains in place. When coupler C is removed, so is the restriction on movement, such that the cam 30 may travel a distance sufficient to release the pins 22a, 22b from the receiver R (the second mode of operation). As can be appreciated, the arrangement could also be done such that the tow ball B itself prevents the full movement of the pull 26. However, this would require removal of the tow ball B prior to being able to release the ball mount M, which is extra effort and perhaps less preferred.

From FIG. 2, it can perhaps be best appreciated that the pull 26 may comprise a front wall 26a opposing the tow ball B, as well as side walls 26b, 26c that are sloped along a rear edge to engage the sloping face 16b of the platform 16. This arrangement forms a gap G along a top portion of the pull 26 that may be sized for receiving one or more fingers. Finger action on one hand may thus be used to move the pull 26 rearwardly and thus overcome the biasing force created by spring 32 when the coupler C is not present, while the other hand may be used to grip and slide the ball mount M from the receiver R once the pins 22a, 22b are released. As a result, the release of the ball mount M from the operative position is made very simple.

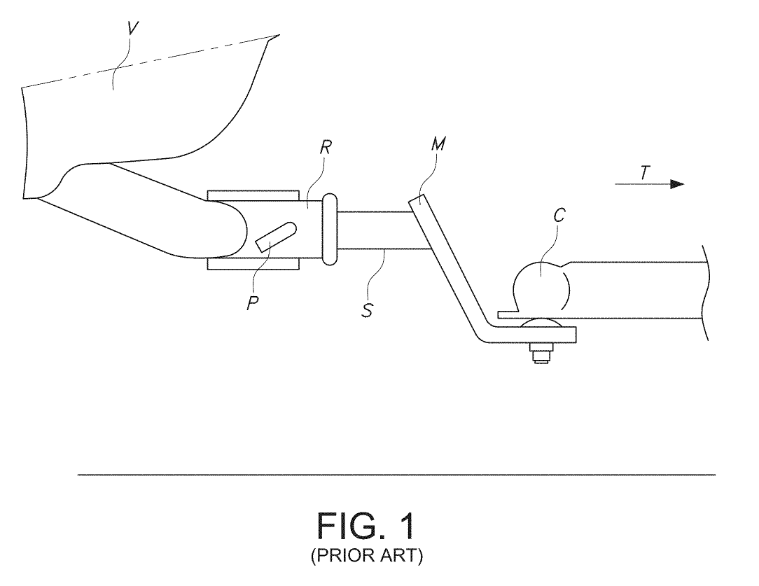

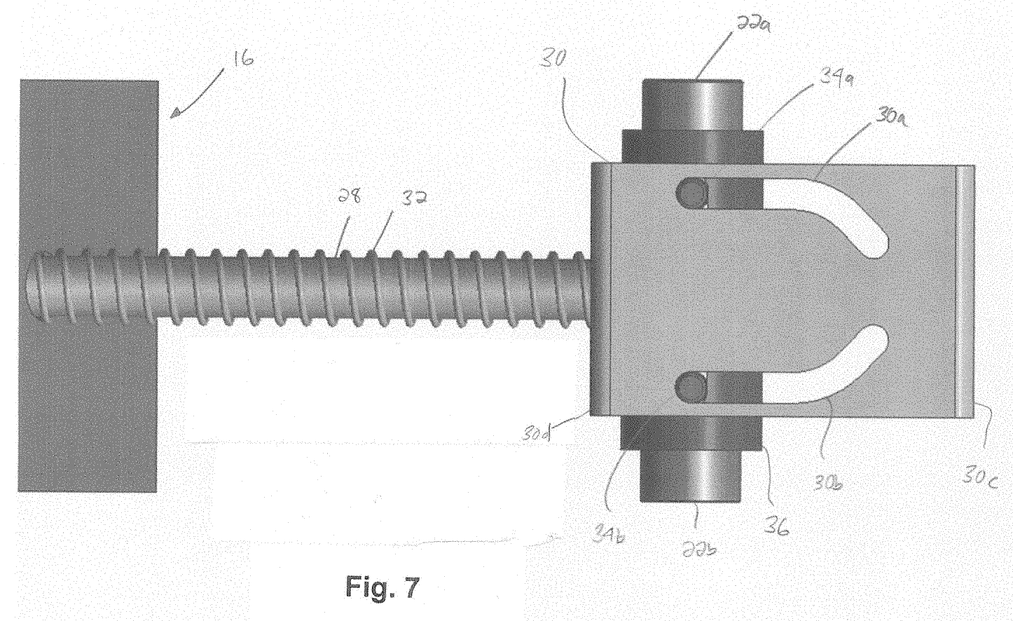

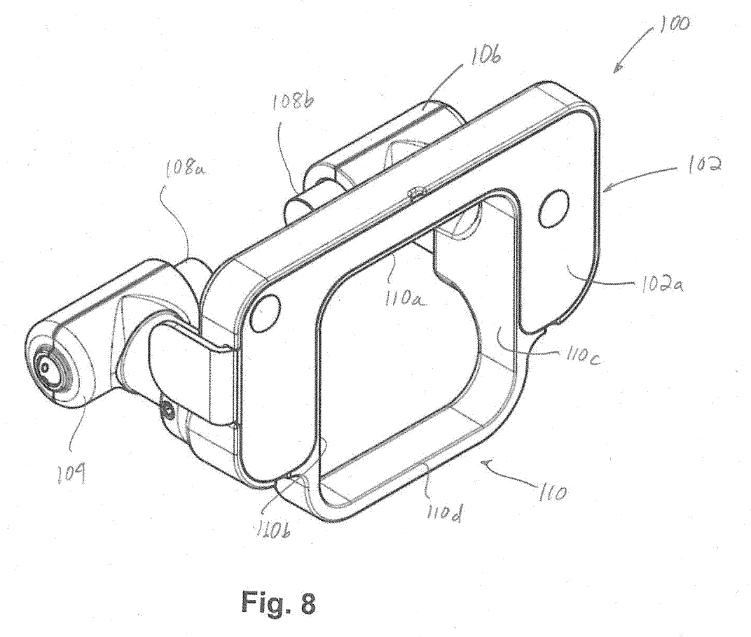

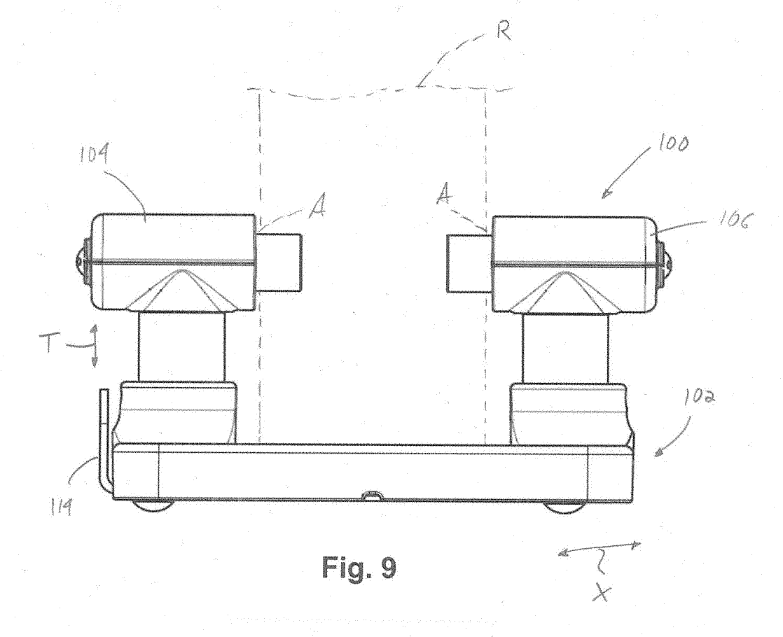

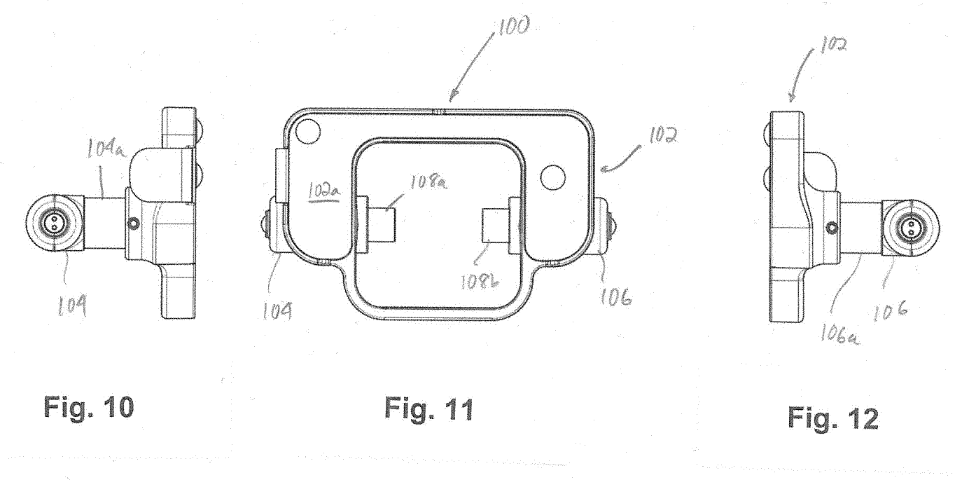

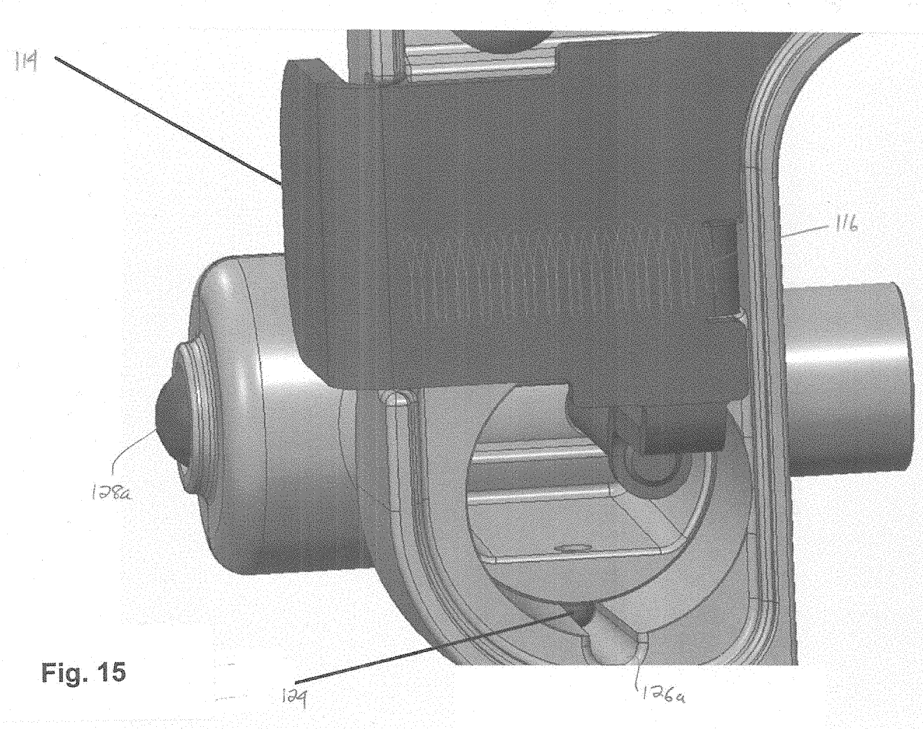

A second embodiment of the retainer 100 is illustrated in FIGS. 8-15, which in this embodiment comprises a portable device adapted for positioning retaining a ball mount M to a hitch receiver R, such as in lieu of pin P (FIG. 1). In FIGS. 8 and 9, it can be understood that the retainer 100 includes a support 102 supporting first and second receivers 104, 106. Each receiver 104, 106 is adapted for receiving a movable pin 108a, 108b for connecting with the hitch receiver R, such as by passing into the corresponding aligned apertures (see FIG. 9) into engagement with an object therein, such as a ball mount (not shown).

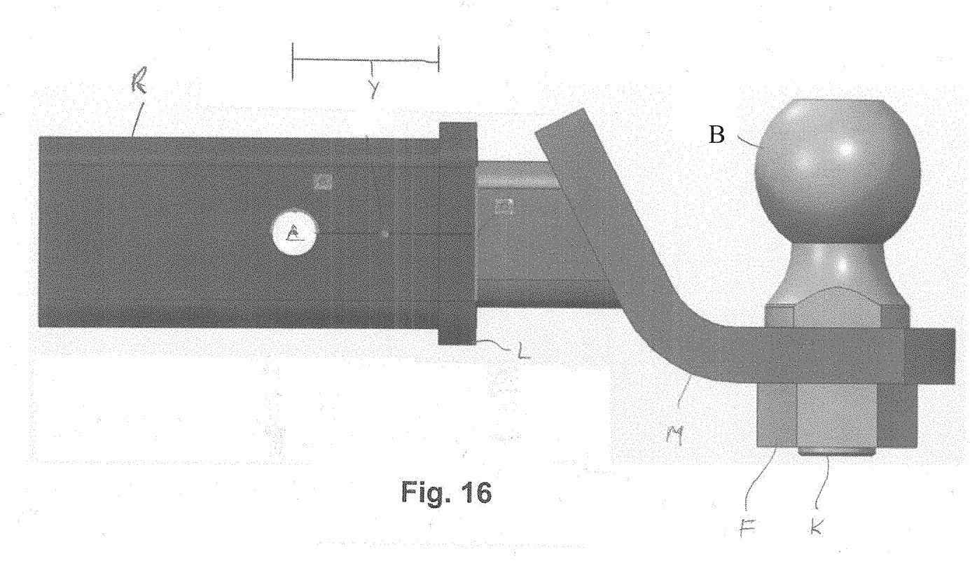

According to one aspect of the disclosure, the support 102 is adapted for positioning on or over an exterior of the receiver R, rather than within it as in the previously described arrangement. The support 102 thus includes a collar 110 having an upper portion 110a corresponding to an upper face of the receiver, side portions 110a, 110b corresponding to the lateral sides of the receiver, and an lower portion 110d corresponding to the lower face of the receiver (which portion 110d is considered optional, in which case the support 102 would be generally U-shaped). In one particular embodiment, the collar 110 is sized for fitting over and engaging an oversized lip L on the periphery of the receiver R (see FIG. 16), but this is considered optional.

The retainer 100 in this embodiment also includes an actuator 112 for causing movement of the pins 108a, 108b to connect a structure, such as a ball mount, to a hitch receiver R. As with the first embodiment, the actuator 112 comprises handle in the form of a pull 114 connected to the pins 108a, 108b for causing to and fro movement in the transverse direction X. Specifically, the pull 114 is normally biased by a spring 116 toward a position for causing associated connectors 118a, 118b to move within corresponding slots 120a, 120b formed in tubular extensions 104a, 106a of the receivers 104, 106 for receiving the pins 108a, 108b and allowing for movement in the transverse direction X. Moving the pull 114 outwardly in the transverse direction X away from the adjacent lateral side of the hitch receiver R thus causes sliding movement of the connector 118 and thus moves the pin 108a toward a retracted or withdrawn condition.

The pull 114 is in turn connected to a pivotally mounted follower 122, which connects to the connector 118b associated with pin 108b. In the home position of pull 114, the follower 112 is arranged so as to correspond to a forward position of the connector 118b in the slot 120b, and thus the extended position of the pin 108b. When the pull 114 is actuated to overcome the biasing force of spring 116, the follower 112 pivots to move the connector 118b within the slot 120b and thereby move the pin 108b substantially simultaneously with the pin 108a. In this manner, the retainer 100 can easily be used to retain the ball mount M or other structure in connection with a hitch receiver R and, as a result of the biasing force created, helps to prevent inadvertent release. As can be appreciated, with the exception of pull 114, the actuator 112 is substantially confined within the body 102 of the retainer 100, and may be protected by an associated cover 102a.

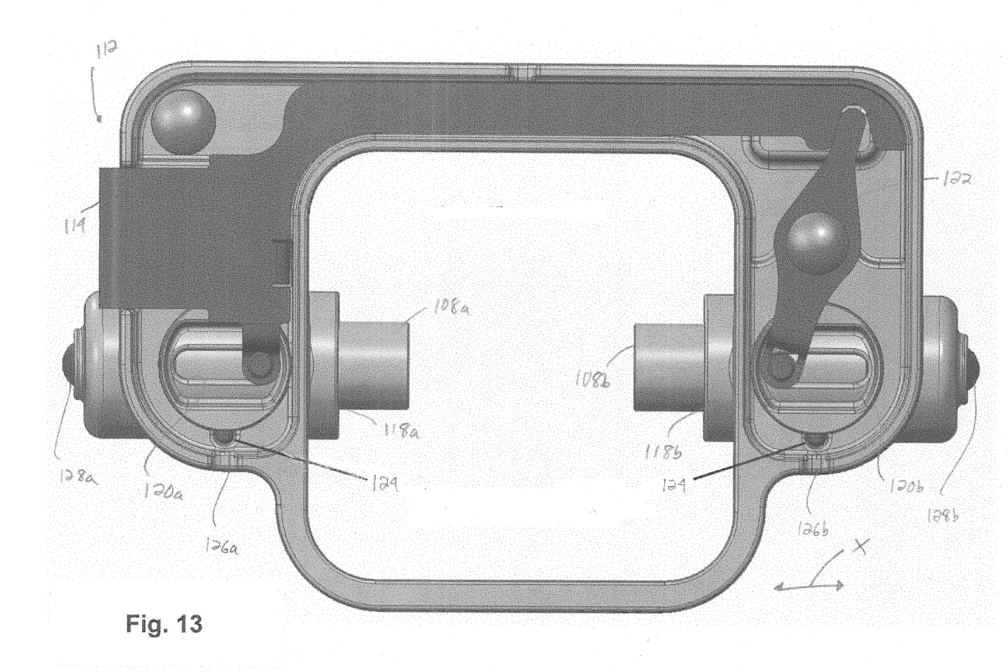

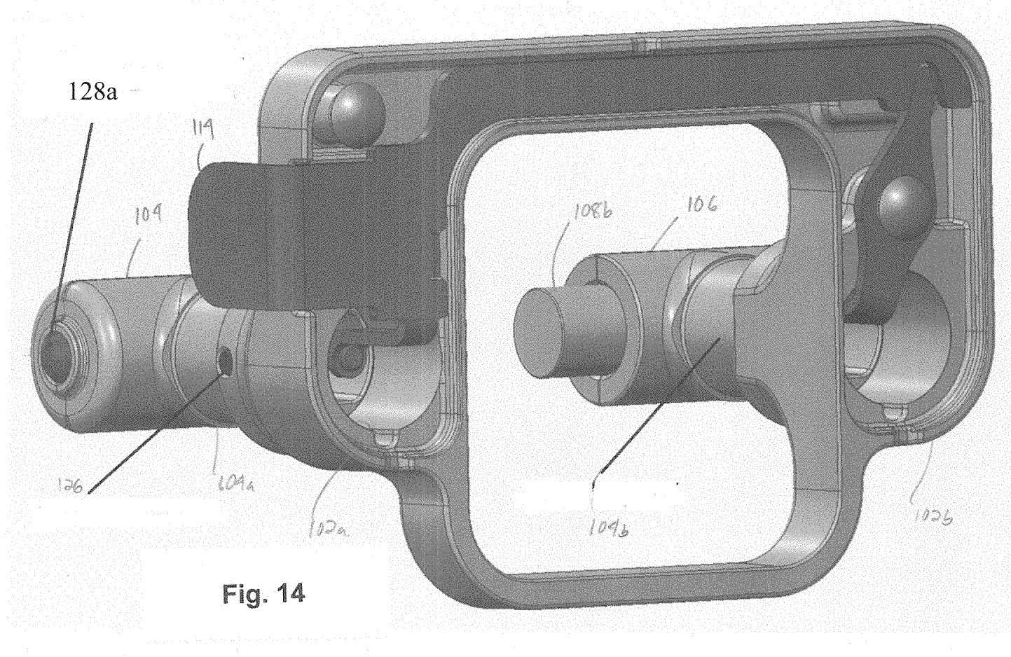

It should also be appreciated that, given the fairly common diameter of hitch receivers, the retainer 100 in this embodiment can be easily retrofitted for use with existing hitch arrangements. In this regard, it is noted that the distance Y between the existing aperture A and a forward lip L on the receiver R may vary (see FIG. 16). In this regard, and with reference back to FIGS. 8-15, it can be understood that the relative distance between the support 102 and the receivers 104, 106 may be independently adjusted by moving the corresponding tubular extension 104a, 106a within the corresponding opening 102a, 102b formed in the support 102. As perhaps best understood in FIGS. 13 and 14, pins 124 may be provided in slots 126a, 126b within the openings 102a, 102b for preventing relative rotation of the extensions 104a, 106a. An externally accessible fastener, such as a set screw 126, may also be provided for holding the receivers 104, 106 in the desired position once the adjustment is made.

With continued reference to FIGS. 13 and 14, an added level of security may also be provided by way of releasable stops for blocking the unwanted movement of the pins 108a, 108b once secured in place. In one embodiment, these stops take the form of screws 128a, 128b having externally accessible heads and shanks within the receivers 104, 106b. In the withdrawn position, the screws 128a, 128b do not interfere with the normal movement of the pins 108a, 108 between the extended and retracted positions. When the pins 108a, 108b are extended, the screws 128a, 128b may be tightened down to prevent the pins from being retracted, even when an attempt is made to do so using the pull 114. Aside from preventing inadvertent release, this may also serve as a theft deterrent. An optional receiver for receiving a lock, such as a padlock, may additionally or alternatively be provided.

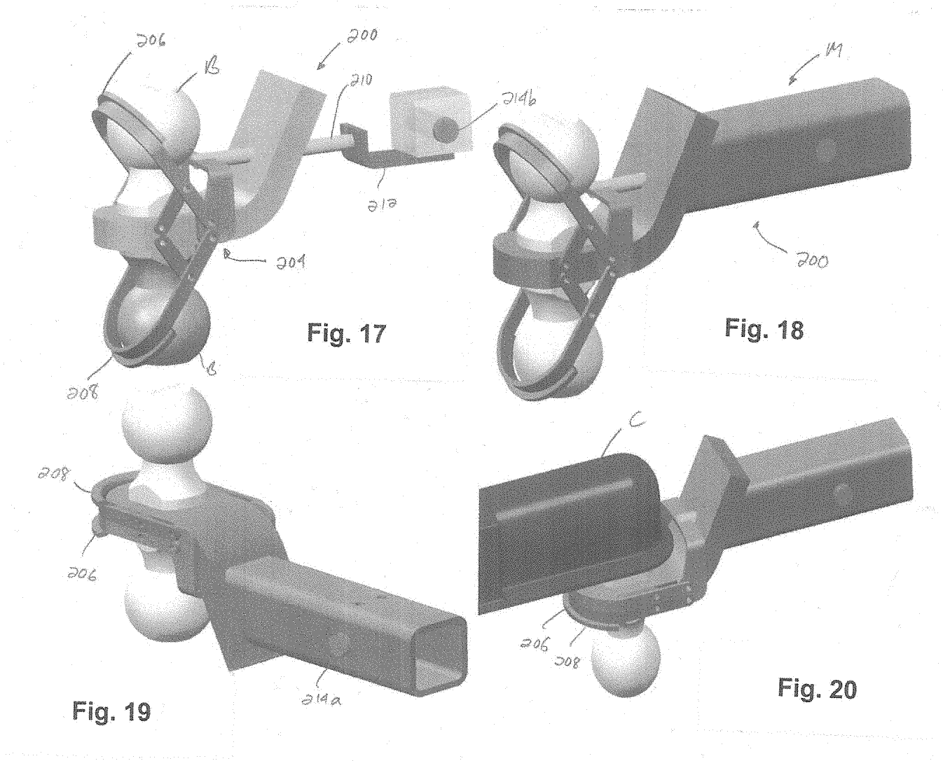

A skilled artisan can appreciate that other arrangements are possible in light of the above teachings. For example, with reference to FIGS. 17-20, a retainer 200 similar to that of FIG. 2 in some respects may be provided in connection with a ball mount M. The pull 204 in this embodiment comprises a linkage including at least one and preferably a pair of jaws 206, 208 that extend over each of two opposed tow balls B (which may be different sizes) when positioned on the ball mount M. The jaws 206, 208 via linkage 204 are connected to a connector in the form of a rod 210 that serves to move a cam 212 and retract the pins 214a, 214b when the jaws are in the open condition. When the jaws are closed, as in FIG. 19, the pins 214a, 214b are extended. Thus, as can be appreciated, when the coupler C is in position on the active tow ball B, as shown in FIG. 20, movement of the jaws 206, 208 is prevented in a manner that would cause pins 214a, 214b to retract and release.

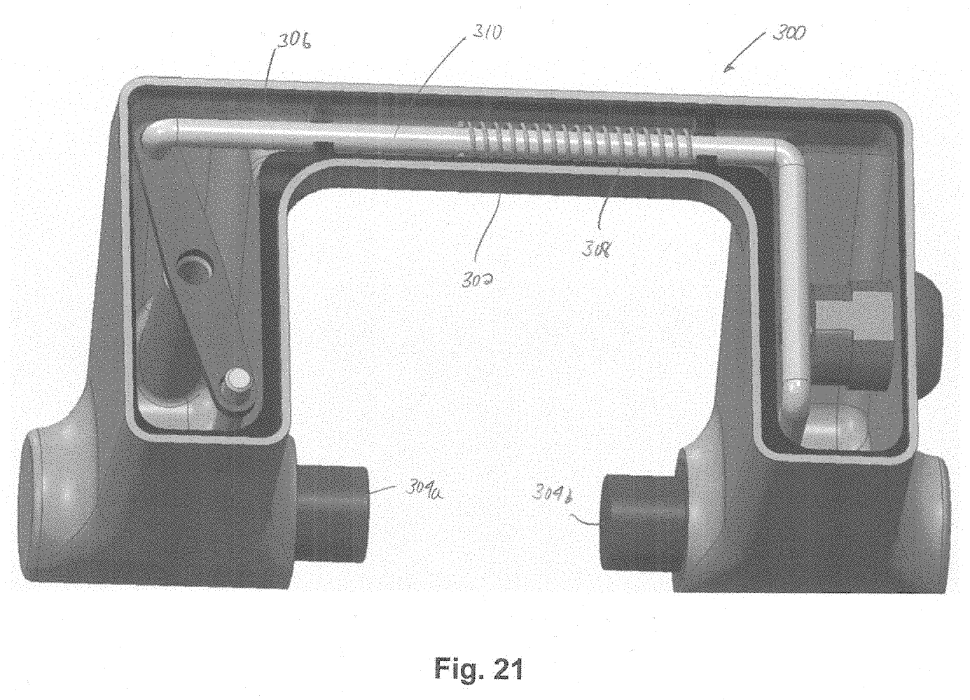

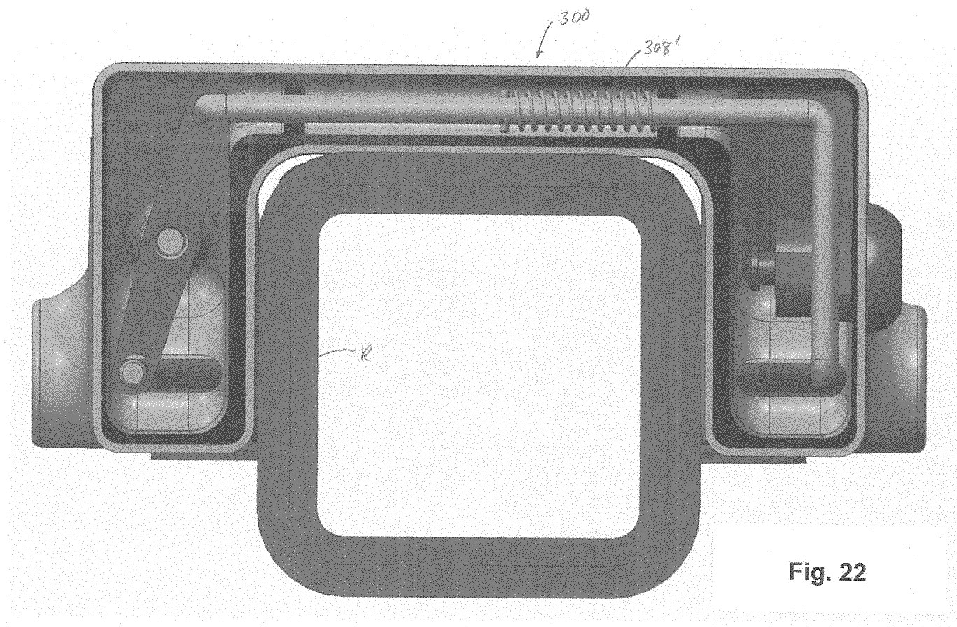

FIG. 21 illustrates a further embodiment of a retainer 300 having a U-shaped body 302 that houses an actuator 306 for releasing and extending pins 304a, 304b for engaging a hitch receiver R (and, in particular, an object associated with the receiver, such as ball mount). As compared with FIG. 8, one difference in this embodiment is the actuator 306 includes a spring 308 is provided within the body 302 for biasing the pins 304a, 304b toward an extended condition. Retraction may be achieved by a slide mechanism (not shown) for moving a bar 310 of a linkage, which in turn compresses the spring 308′ and retracts the pins 304a, 304b (see FIG. 22).

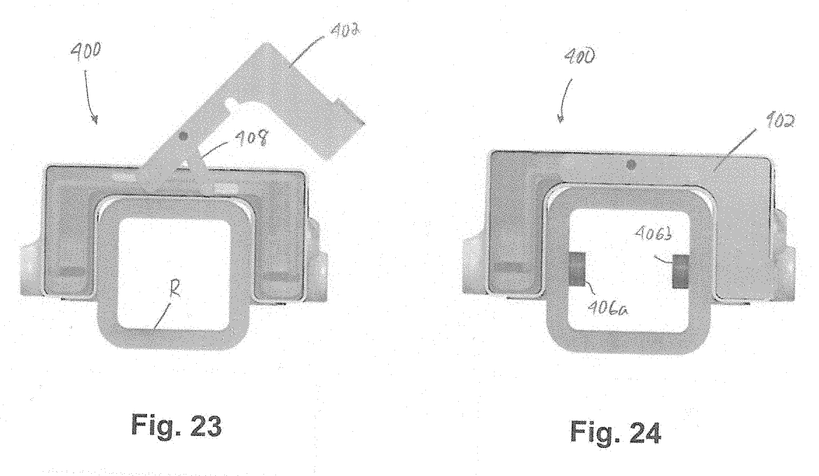

FIGS. 23 and 24 illustrate another embodiment of a retainer 400 in which the pull 402 is adapted for being raised and lowered relative to a support 404 for supporting the pins 406a, 406b for extension and retraction relative to the receiver R. An associated linkage including a connector 408 serves to move the pins 406a, 406b to and fro as a result of the raising and lowering of the pull 402 (compare FIGS. 23 and 24).

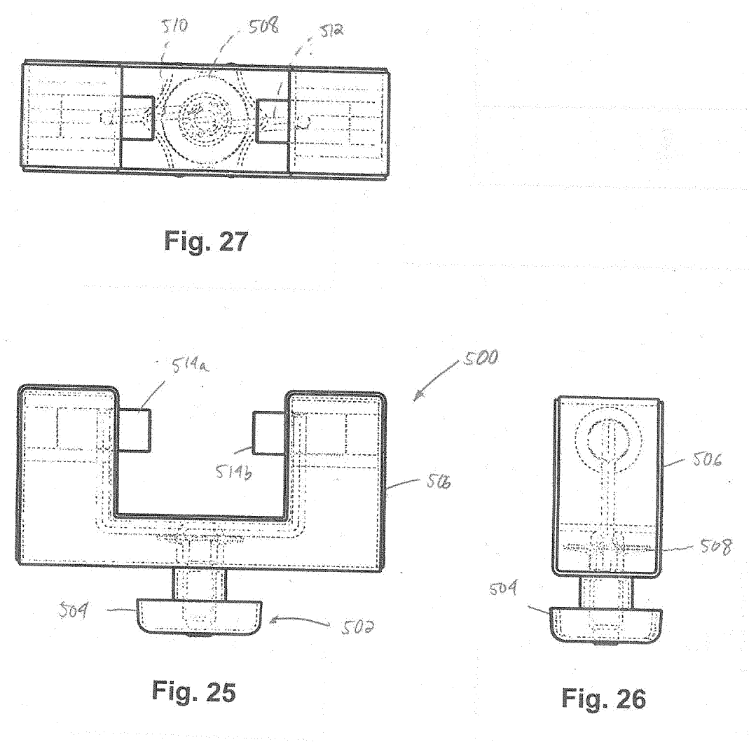

The retainer 500 may also include a rotary actuator 502, as shown in FIGS. 25-27. The actuator 502 may comprise a handle 504 connected to the support 506 in a manner for rotating a plate 508 connected to links 510, 512 connected to pins 514a, 514b. Relative rotation of the handle 504 thus causes the pins 514a, 514b to extend or retract. As can be appreciated, the support 506 in this embodiment is generally U-shaped for fitting externally over the receiver (not shown). Thus, as should be appreciated, it may be used above or below the receiver, as desired.

In summary, a releasable retainer 10, 100, 200, 300, 400, or 500 for a hitch arrangement provides for the secure attachment of the ball mount M to prevent inadvertent release, including when a coupler C is present on a tow ball B, yet would still be easily released when desired. The retainer does not interfere with the normal operation of the hitch arrangement and, in some embodiments, could be used in a retrofit situation with existing hitch technology.

The foregoing has been presented for purposes of illustration and description. It is not intended to be exhaustive or to limit the embodiments to the precise form disclosed. Obvious modifications and variations are possible in light of the above teachings. For instance, while two retractable pins are shown, it should be appreciated that only one such pin could be used with success to retain the hitch assembly in the operative condition (including possibly with a conventional pin, the retainer thus serving as an added level of security). Furthermore, the retainer 100, 300, 400, 500 could be made as an integral part of a hitch receiver R, rather than as a separate component. All such modifications and variations are within the scope of the appended claims when interpreted in accordance with the breadth to which they are fairly, legally and equitably entitled.

What is claimed:

1. An apparatus for connecting a coupler associated with a trailer to a hitch receiver using a tow ball for connecting the trailer to a vehicle via the coupler, comprising:
a ball mount for supporting the tow ball, the ball mount including a retainer having a first pin for engaging the hitch receiver and an actuator for withdrawing the first pin from engagement with the hitch receiver, the actuator configured to prevent the withdrawal of the first pin for disconnecting the ball mount from the hitch receiver when the coupler is connected to the tow ball.

2. The apparatus of claim 1, wherein the actuator comprises a handle, a connector connected to the handle, and a cam connected to the connector for engaging the first pin.

3. The apparatus of claim 2, wherein the cam comprises a slot for engaging a follower connected to the first pin, the slot adapted for causing the first pin to move to and fro in a direction transverse to a towing direction.

4. The apparatus of claim 3, wherein the connector is biased for maintaining the first pin in engagement with the hitch receiver.

5. The apparatus of claim 1, wherein the retainer includes a second pin for engaging the hitch receiver, and wherein the actuator is configured for simultaneously withdrawing the first and second pins from engagement with the hitch receiver.

6. The apparatus of claim 5, wherein the actuator comprises a handle, a connector connected to the handle, and a cam connected to the connector for engaging the first and second pins, the cam comprising:
a first slot for engaging a first follower connected to the first pin, the first slot adapted for causing the first pin to move to and fro transverse to a towing direction, and
a second slot for engaging a second follower connected to the second pin, the second slot adapted for causing the second pin to move to and fro transverse to the towing direction.

7. The apparatus of claim 1, wherein the actuator is adapted for moving toward the coupler when present on the tow ball an amount less than a distance required to release the first pin from engagement with the receiver.

8. The apparatus of claim 1, wherein the ball mount includes a platform having a sloping portion, and the actuator comprises a handle mounted adjacent to the sloping portion so as to form a gap configured for receiving a finger of an operator for engaging the handle and moving it toward the tow ball to release the retainer.

9. The apparatus of claim 9, wherein the handle is connected to a connector extending through an aperture in the sloping portion.

10. An apparatus for connecting a coupler associated with a trailer to a hitch receiver using a tow ball for connecting the trailer to a vehicle via the coupler, comprising:
a ball mount for supporting the tow ball, the ball mount including a retainer having a first pin for engaging the hitch receiver and a movable cam for engaging and withdrawing the first pin from engagement with the hitch receiver, the cam having a first travel amount in a first mode of operation that is less than an amount required to withdraw the first pin from engagement with the hitch receiver and a second travel amount in a second mode of operation that is greater than the amount required to withdraw the first pin from engagement.
